(19) United States
(12) Patent Application Publication
(10) Pub. No.: US 2025/0308233 A1
(43) Pub. Date: Oct. 2, 2025

(54) Dynamic Light Adjustment for Machine Vision

(71) Applicant: Ag Leader Technology, Inc., Ames, IA (US)

(72) Inventors: Trent Anagnostopoulos, Ankeny, IA (US); Josue Calderon, Apex, NC (US); Scott Eichhorn, Ames, IA (US)

(73) Assignee: Ag Leader Technology, Inc., Ames, IA (US)

(21) Appl. No.: 19/091,796

(22) Filed: Mar. 26, 2025

Related U.S. Application Data
(60) Provisional application No. 63/571,941, filed on Mar. 29, 2024.

(51) Int. Cl. G06V 20/10; G06T 7/90; G06V 10/56; G06V 10/60; G06V 10/764

(52) U.S. Cl. CPC G06V 20/188; G06T 7/90; G06V 10/56; G06V 10/60; G06V 10/764; G06V 2201/07

(57) ABSTRACT

A method for dynamically adjusting machine vision for agricultural applications includes capturing, via at least one camera mounted on an agricultural vehicle, image data of plants in an agricultural field, obtaining reference data from a calibration element within the field of view of the at least one camera, wherein the calibration element provides a baseline for visual comparison under changing environmental lighting conditions, detecting a change in environmental lighting conditions by comparing current visual characteristics of the calibration element to predetermined baseline visual characteristics, calculating adjustment values for parameters of a machine vision algorithm based on the detected change in environmental lighting conditions, modifying the parameters of the machine vision algorithm according to the calculated adjustment values, and processing the image data with the modified machine vision algorithm to identify plants in the agricultural field.

### PRIORITY STATEMENT

This application claims priority to U.S. provisional patent application No. 63/571,941, filed Mar. 29, 2024, entitled “Dynamic Light Adjustment for Machine Vision”, which is hereby incorporated by reference in its entirety.

### FIELD OF THE DISCLOSURE

The present disclosure relates to machine vision. More particularly, but not exclusively, the present disclosure relates to dynamic light adjustment for machine vision in agricultural applications.

### BACKGROUND

There is a need to visually identify and locate crops, weeds, or other plants within a field and in outdoor conditions. Existing algorithms struggle with the wide variety of lighting resulting from changes in the time of day and the weather. For example, the soil may change color as it gets wet, puddles may form and reflect the sky, plants themselves may change color or shape based during rainfall or changes in time of day, and as the sun rises or sets it may shine directly into the camera and shift the color space of the image significantly.

Neural net based algorithms are well known to suffer sudden and unexpected levels of error from minor variations. There are no guarantees of stability or error accrual with neural net based algorithms. Minor changes in color, such as from a cloud passing and blocking the sun, may render an accurate plant finding neural net useless depending on its design and training. Some neural nets attempt to learn while running actively, but without careful control of the sample images this process usually increases the error.

Color threshold based algorithms rely on carefully selected thresholds to locate the targeted plants. The error is more predictable with this type of algorithm. However, the sun is sufficiently bright to white shift the color space to the degree the algorithm fails. The camera used may also adjust its settings dynamically and cause a black shift of the color space and similarly cause the algorithm to fail.

One existing solution is to cover the area being viewed with a hood. The hood allows greater control of the light in the area the camera is viewing by blocking direct sun light. These hoods are often dragged behind the vehicle and cover the area of operation. The structured light inside the hood reduces the variables the algorithm must contend.

Other solutions provide large lights that produce a structured light without any kind of shade or hood. These lights attempt to provide a consistent brightness and temperature of light to reduce the variability in the image. Further, these lights may pulse or flash at a specific rate to reduce shutter errors with the camera or to allow a much brighter output with less power usage.

No known solution fully addresses the issue of varying light conditions and weather. No series of LED lights is sufficient to outpower the sun, raindrops may reflect that light and obstruct any imagery obtained and the addition of hoods and lights is onerous to the end user. Therefore, methods and systems to dynamically adjust either a color threshold or a neural net based algorithm with minimal power usage and small installation footprints are needed.

### SUMMARY

Therefore, it is a primary object, feature, or advantage of the present disclosure to improve over the state of the art.

It is a further object, feature, or advantage of the present disclosure to provide dynamic adjustment capabilities for machine vision algorithms used in agricultural applications under varying light and weather conditions.

It is a still further object, feature, or advantage of the present disclosure to enhance the reliability and accuracy of plant detection systems without necessarily requiring extensive computational resources or specialized hardware.

Another object, feature, or advantage is to enable real-time adaptation of color threshold and neural network-based algorithms to changing environmental conditions in outdoor agricultural settings.

Yet another object, feature, or advantage is to provide multiple complementary techniques for calibrating machine vision systems, including neural net correction of color thresholds, growth-stage-specific algorithm adjustments, sample plant reference methods, color reference squares, and incident light color temperature and intensity sensing.

A further object, feature, or advantage is to minimize computational overhead by executing resource-intensive neural networks only when necessary to calibrate lighter-weight color threshold algorithms.

Another object, feature, or advantage is to maintain consistent plant detection accuracy throughout various growth stages by dynamically loading stage-appropriate algorithm parameters.

A still further object, feature, or advantage is to provide robust plant identification without requiring cumbersome physical solutions such as hoods or high-powered lighting systems.

Yet another object, feature, or advantage is to enable accurate detection of plant stresses, diseases, deficiencies, and damage by maintaining precise color recognition capabilities despite variable environmental conditions.

Another object, feature, or advantage is to improve row following accuracy for autonomous or guided agricultural equipment by enhancing the reliability of plant and row detection.

Yet another object, feature, or advantage is to generate more accurate guidance lines for agricultural equipment using machine vision.

A further object, feature, or advantage is to facilitate nighttime and low-light agricultural operations through adaptive algorithm adjustments based on artificial lighting conditions.

One or more of these and/or other objects, features, or advantages of the present disclosure will become apparent from the specification and claims that follow. No single embodiment need provide each and every object, feature, or advantage. Different embodiments may have different objects, features, or advantages. Therefore, the present disclosure is not to be limited to or by any objects, features, or advantages stated herein.

According to one aspect, a method for dynamically adjusting machine vision for agricultural applications is provided. The method includes capturing, via at least one camera mounted on an agricultural vehicle, image data of plants in an agricultural field. The method further includes obtaining reference data from a calibration element within the field of view of the at least one camera, wherein the calibration element provides a baseline for visual comparison under changing environmental lighting conditions. The method further includes detecting a change in environmental lighting conditions by comparing current visual characteristics of the calibration element to predetermined baseline visual characteristics. The method further includes calculating adjustment values for parameters of a machine vision algorithm based on the detected change in environmental lighting conditions. The method further includes modifying the parameters of the machine vision algorithm according to the calculated adjustment values. The method further includes processing the image data with the modified machine vision algorithm to identify plants in the agricultural field. The calibration element may include a sample plant positioned on a contrasting background, color calibration squares with predetermined color values, and/or a color temperature and intensity sensor. The machine vision algorithm may include a color threshold algorithm with predetermined threshold values and the step of modifying the parameters may include adjusting the predetermined threshold values to compensate for the detected change in environmental lighting conditions. The method may further include executing a neural network algorithm at specified intervals to generate reference plant identification results from the image data. The method may further include comparing output from the color threshold algorithm with output from the neural network algorithm to calculate an error score. The method may further include adjusting the predetermined threshold values of the color threshold algorithm to minimize the error score. The step of detecting the change in environmental lighting conditions may include measuring at least one metric selected from the group consisting of: ambient light color temperature, light intensity, and color values of the calibration element and calculating a numerical difference between current values and baseline values for each measured metric. The method may further include classifying a growth stage of the plants in the agricultural field using an image classifier and selecting a set of baseline algorithm parameters corresponding to the classified growth stage prior to modifying the parameters. The calibration element may include a sample plant positioned on a contrasting background/The step of obtaining reference data may include isolating the sample plant from the contrasting background to create a reference mask and calculating adjustment values based on comparing plant identification results from the machine vision algorithm with the reference mask. The calibration element may include color calibration squares with predetermined color values. The method may further include obtaining reference data which includes capturing an image of the color calibration squares and the step of calculating adjustment values may include determining differences between expected detection results and actual detection results for the color calibration squares. The calibration element may include a color temperature and intensity sensor and the step of obtaining reference data may include acquiring color temperature and intensity measurements from the sensor and the step of detecting the change in environmental lighting conditions may include calculating a numerical vector between current measurements and baseline measurement. The step of calculating adjustment values may include applying the numerical vector to determine specific parameter modifications for the machine vision algorithm. The step of processing the image data with the modified machine vision algorithm may result in output for use include performing at least one function such as plant identification, row guidance, plant stress detection, and weed discrimination.

According to another aspect, a method for dynamically adjusting a machine vision system for agricultural applications is provided. The method includes: capturing image data of an agricultural field via at least one camera; processing the image data with a computationally intensive neural network algorithm at a first frequency to generate a neural network plant identification mask; processing the same image data with a computationally efficient color threshold algorithm at a second frequency higher than the first frequency to generate a color threshold plant identification mask; comparing the neural network plant identification mask with the color threshold plant identification mask to calculate an error score; adjusting parameters of the color threshold algorithm based on the error score; and processing subsequent image data with the adjusted color threshold algorithm to identify plants in the agricultural field. The method of claim 1, wherein comparing the neural network plant identification mask with the color threshold plant identification mask may further include: incrementing the error score for each pixel where the neural network mask indicates plant presence and the color threshold mask does not; and decrementing the error score for each pixel where the neural network mask does not indicate plant presence and the color threshold mask does. The adjusting parameters of the color threshold algorithm may include widening threshold ranges when the error score is positive and narrowing threshold ranges when the error score is negative. The adjusting parameters of the color threshold algorithm may further include applying a gradient descent algorithm to iteratively modify the parameters until the error score reaches a minimum value. The first frequency may be selected to minimize computational resource utilization while maintaining accuracy of the color threshold algorithm under changing environmental lighting conditions.

According to another aspect, a method for dynamically adjusting a machine vision system for agricultural applications is provided. The method includes capturing image data of an agricultural field via at least one camera; classifying a growth stage of plants in the agricultural field by processing the image data with a growth stage classifier. The method further includes selecting a pre-configured set of algorithm parameters corresponding to the classified growth stage from a database of growth stage-specific algorithm parameters, configuring a plant identification algorithm with the selected pre-configured set of algorithm parameters, and processing the image data with the configured plant identification algorithm to identify plants in the agricultural field.

According to another aspect, a method for dynamically adjusting a machine vision system for agricultural applications is provided. The method includes mounting a calibration fixture at a fixed location relative to at least one camera on an agricultural vehicle, wherein the calibration fixture includes a contrasting background. The method further includes securing a sample plant on the calibration fixture, wherein the sample plant is of the same type as target plants in an agricultural field. The method further includes capturing image data including both the agricultural field and the calibration fixture with the sample plant, isolating the sample plant from the contrasting background to create a reference plant mask, processing an image of the sample plant with a plant identification algorithm to generate an algorithm plant mask, comparing the reference plant mask with the algorithm plant mask to determine adjustment values for algorithm parameters, and processing image data of the agricultural field with the plant identification algorithm using the adjusted algorithm parameters. The contrasting background may include a surface of a predetermined color that contrasts with plant colors. The step of isolating the sample plant from the contrasting background may include filtering out pixels matching the predetermined color of the contrasting background. The step of comparing the reference plant mask with the algorithm plant mask may include calculating a pixel-by-pixel difference between the masks. The method may further include periodically replacing the sample plant to account for changes in plant appearance due to growth stage progression.

According to yet another aspect, a method for dynamically adjusting a machine vision system for agricultural applications is provided. The method includes mounting color calibration squares at a fixed location relative to at least one camera on an agricultural vehicle, wherein the color calibration squares have predetermined colors representing target plant colors. The method further includes capturing image data including both an agricultural field and the color calibration squares, identifying the color calibration squares within the captured image data based on their known position, processing an image of the color calibration squares with a plant identification algorithm, comparing the algorithm's detection results of the color calibration squares with expected detection results to calculate parameter adjustment values, modifying parameters of the plant identification algorithm based on the calculated parameter adjustment values, and processing image data of the agricultural field with the modified plant identification algorithm. The color calibration squares may include at least one color selected to match a specific feature of target plants. The step of comparing the algorithm's detection results may include determining whether the algorithm correctly classifies each color calibration square as plant or non-plant material. The predetermined colors of the color calibration squares may represent different plant parts or plant health conditions.

According to yet another aspect, a method for dynamically adjusting a machine vision system for agricultural applications is provided. The method includes mounting a color temperature and intensity sensor on an agricultural vehicle to measure incident light conditions, capturing image data of an agricultural field via at least one camera on the agricultural vehicle, measuring current color temperature and intensity of incident light using the color temperature and intensity sensor, calculating a difference vector between the current color temperature and intensity measurements and baseline color temperature and intensity measurements, adjusting parameters of a plant identification algorithm by applying the difference vector to baseline algorithm parameters, and processing the captured image data with the adjusted plant identification algorithm to identify plants in the agricultural field. The color temperature and intensity sensor may be positioned to measure light conditions similar to those affecting the plants being imaged by the at least one camera. The step of calculating the difference vector may include determining both magnitude and direction of change in color temperature and intensity. The step of applying the difference vector to baseline algorithm parameters may include proportionally shifting color threshold values based on the magnitude and direction of the difference vector. The method may further include creating a lookup table correlating specific color temperature and intensity measurements with optimal algorithm parameters.

According to another aspect, a system for dynamically adjusting machine vision for agricultural applications is provided. The system includes at least one camera mounted on an agricultural vehicle configured to capture image data of plants in an agricultural field/The system further includes a calibration element positioned within a field of view of the at least one camera, wherein the calibration element provides a baseline for visual comparison under changing environmental lighting conditions. The system further includes a processor and a memory storing instructions that, when executed by the processor, cause the system to: obtain reference data from the calibration element; detect a change in environmental lighting conditions by comparing current visual characteristics of the calibration element to predetermined baseline visual characteristics, calculate adjustment values for parameters of a machine vision algorithm based on the detected change in environmental lighting conditions, modify the parameters of the machine vision algorithm according to the calculated adjustment values, and process the image data with the modified machine vision algorithm to identify plants in the agricultural field. The calibration element may include one or more of the following: a sample plant positioned on a contrasting background, color calibration squares with predetermined color values, and a color temperature and intensity sensor. The machine vision algorithm may include a color threshold algorithm with predetermined threshold values. The modifying the parameters may include adjusting the predetermined threshold values to compensate for the detected change in environmental lighting conditions. The instructions may further cause the system to execute a neural network algorithm at specified intervals to generate reference plant identification results from the image data, compare output from the color threshold algorithm with output from the neural network algorithm to calculate an error score, and adjust the predetermined threshold values of the color threshold algorithm to minimize the error score. The calibration element may include a sample plant positioned on a contrasting background, and instructions for obtaining reference data may include instructions for isolating the sample plant from the contrasting background to create a reference mask. The system may further include a vehicle steering control system, wherein the instructions further cause the system to identify crop rows in the agricultural field using the modified machine vision algorithm, determine guidance lines between the identified crop rows, and transmit control signals to the vehicle steering control system to guide the agricultural vehicle between the crop rows. The instructions may further cause the system to classify a growth stage of the plants in the agricultural field and select a set of baseline algorithm parameters corresponding to the classified growth stage prior to modifying the parameters.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Illustrated aspects of the disclosure are described in detail below with reference to the attached drawing figures, which are incorporated by reference herein.

FIGS. 1A, 1B, 1C, 1D, 1E, 1F, and 1G illustrate using a neural net correcting color threshold. FIG. 1A illustrates a plant identified by a neural net. FIG. 1B illustrates a neural net semantic separated plant. FIG. 1C illustrates a color threshold plant selection. FIG. 1D illustrates a color threshold plant mask. FIG. 1E illustrates a neural net plant mask. FIG. 1F illustrates another neural net plant mask. FIG. 1G illustrates a color threshold algorithm post threshold update.

FIG. 2 illustrates a sample plant in a known location with a stark background.

FIGS. 3A, 2B, and 3C illustrate a high contrast plant cutout. FIG. 3A illustrates a plant on a magenta background. FIG. 3B illustrates removing all the magenta pixels. FIG. 3C illustrates the resulting plant mask.

FIG. 4 illustrates using calibration color squares installed in a known location.

FIG. 5 is a block diagram illustrating one example of a system.

FIG. 6 is a flow chart illustrating a method of the present disclosure.

### DETAILED DESCRIPTION

The present disclosure provides for dynamic light adjustment for machine vision suitable for use to visually detect agricultural plants within in agricultural field during varying weather and light conditions. Various agricultural applications rely upon accurately finding plants or rows of plants or assessing presence of pests, disease, damage, or deficiencies within plants.

Correct Color Threshold with Neural Net

Some embodiments of the present disclosure combine color threshold algorithms with neural networks to provide enhanced plant detection in varying field conditions. Color threshold algorithms offer significant advantages for identifying plants in agricultural applications due to their speed, minimal processing requirements, and generally stable performance across various environmental conditions. However, these algorithms lack the sophistication of neural networks and may fail under unusual lighting conditions or when confronted with unexpected variations in plant appearance.

The disclosed method addresses these limitations by implementing a hybrid approach that leverages both technologies while mitigating their respective weaknesses. A neural network trained specifically to identify the target plant classes is executed intermittently at a deliberately reduced frequency, while the color threshold algorithm continues to operate at full video frame rates. This asynchronous processing allows the neural network to analyze frames in the background without disrupting the real-time operation of the color threshold algorithm.

When the neural network completes its analysis of a frame, it produces a segmented image highlighting only the target plant class. This segmentation is converted to a binary mask where white pixels represent identified plant material and black pixels represent non-plant elements. Simultaneously, the same original image frame is processed through the current color threshold algorithm to generate a second binary mask. Both masks represent the same scene but are processed through different methodologies.

The system then performs a detailed comparison between these masks. A pixel-by-pixel analysis examines each corresponding position across both masks. An error score is initialized to zero and then modified throughout the comparison process. For each pixel position where the neural network mask shows a plant (white), but the color threshold mask shows non-plant material (black), the error score is incremented. Conversely, where the neural network mask indicates non-plant material (black), but the color threshold mask shows a plant (white), the error score is decremented. The resulting error score may be positive, negative, or zero.

A positive error score indicates that the color threshold algorithm is missing plants that the neural network detects, suggesting false negatives. A negative error score signifies that the color threshold algorithm is identifying non-plant material as plants, indicating false positives. A zero error score represents alignment between the algorithms.

Based on this calculated error score, the system makes precise adjustments to the color threshold algorithm parameters. If the error score is positive, the threshold ranges are widened to capture more potential plant material. If negative, the threshold ranges are narrowed to reduce false positives. With a zero error score, the current threshold values are maintained.

The adjustment process may employ a gradient descent approach to efficiently find optimal threshold values. Multiple iterations of small adjustments may be tested to minimize the error score, with step sizes for threshold changes dynamically adjusted based on the error magnitude. The system may independently adjust different color channels, such as red, green, and blue ranges for RGB thresholds, or hue, saturation, and luminance parameters for HSL/HSV implementations. Systems with depth information may additionally optimize RGBD parameters.

Once the optimization process is complete, the system selects the threshold configuration that produced the minimal error score. These optimized threshold values are stored and applied to the color threshold algorithm, which continues to operate with these updated parameters until the next neural network evaluation cycle.

This approach may be enhanced through several alternative implementations. The error calculation may utilize weighted scoring, assigning higher importance to certain image regions, weighting errors differently based on plant size or growth stage, or applying confidence values from the neural network to proportionally weight error contributions. Rather than a single adjustment cycle, the system may implement multi-stage optimization with coarse adjustments followed by fine-tuning, independent optimization of different parameters, or progressive narrowing of the search space.

The system may also maintain multiple color threshold configurations optimized for various lighting conditions or plant growth stages, with dynamic selection based on environmental factors. Additionally, the neural network itself may be periodically updated using human-verified results from field operations, incorporating seasonal variations in plant appearance, or adapting to specific field conditions.

To further improve computational efficiency, the neural network may process down sampled or cropped images, focus analysis on critical image areas, or use historical patterns to predict optimal threshold adjustments without full neural network execution.

The frequency of neural network execution may be adaptive, adjusting the frequency based on detected rates of environmental change, historical algorithm performance, available computational resources, or power consumption considerations. This allows the system to remain responsive while minimizing resource utilization.

This hybrid approach offers several distinct advantages. By running the neural network infrequently, the system maintains real-time performance on standard hardware without requiring specialized neural network accelerators. The color threshold algorithm continuously benefits from neural network-guided adjustments as lighting and environmental conditions change, resulting in error reduction through quantitative comparison and optimization. The fast execution of the color threshold algorithm provides stable frame rates and consistent system behavior.

This methodology effectively creates a self-calibrating vision system that maintains the speed and efficiency of traditional algorithms while leveraging the adaptive intelligence of neural networks to handle challenging and variable field conditions encountered in agricultural applications.

Any number of different neural networks may be used including convolutional neural networks, semantic segmentation networks, vision transformers, or any number of other types of neural networks as may be appropriate for a particular environment or application.

Color threshold based algorithms for plant location are desirable because they run fast, use minimal processing power and are more stable to changes in the environment. However, the complexity of these algorithms is far less than neural nets and they may fail in certain conditions due to their rigorous definitions of the color or shape of plants and the ground around them. To address these deficiencies the present disclosure provides a method which combines both methods to obtain improved results.

Any color threshold method that relies on any set values describing colors and ascribing those colors to classes of objects starts with a default threshold for each class. The threshold may describe an upper and lower RGB value range, HSL, HSV or even the addition of depth such as RGBD. In this technique a neural net trained to identify the desired class or classes of objects in a wide variety of conditions is executed rarely in order to locate the object class, such as a corn plant. The localization from the neural net is then compared to the localization from the color threshold algorithm and the thresholds are adjusted to reduce the color threshold algorithm's error. The neural net is rarely run to purposefully reduce the total processing power necessary. It is acceptable for the neural net to take longer to complete than the update rate of the color threshold algorithm.

Once the neural net algorithm completes it will output a segmented image highlighting only the target object class. A mask may be generated from the image by setting any portion of the image showing the desired object class to white and the rest of the image set to black. That same image is then passed through the color threshold algorithm, and another mask is generated. Whichever pixels fall within the threshold set for the same type of class the neural net are set to white and the rest set to black. The result is two masks. One mask resenting what the neural net considers to be the target object class, such as a plant, and the other mask representing what the color threshold algorithm currently believes to be the target object class.

The two generated masks, one from the neural net and one from the color threshold algorithm, may be compared. A simple error score may be calculated by finding every pixel from the neural net mask that does not match the color threshold mask. The score is initialized to a zero value. If the neural net pixel is white while the color threshold pixel is black the score may be incremented such as by adding 1 to the score. If the neural net pixel is black while the color threshold pixel is white then the score may be decreased such as by subtracting a value from the score. The end result is a negative score, zero or a positive score.

If the score is negative the algorithm may adjust the threshold of the color threshold algorithm to be narrower and if positive adjust the threshold to be wider. If zero, then no adjustment need be performed. Adjustment may be performed using a gradient descent algorithm. The threshold is adjusted wider or narrower, the image is run through the color threshold algorithm using the newly adjusted threshold, the mask is regenerated, and the algorithm scores the mask difference again. This process may continue for a specified number of iterations or stops short if it fails to reduce the error. Finally, the method may then overwrite the threshold in the color threshold algorithm to the setting which resulted in the lowest error score.

The slowly running neural net reduces the processing power needed but offers the color threshold algorithm an opportunity to adjust based on more complex definition of the target object class. This eliminates the need for special neural net processing hardware, retains the usual fast execution speed of the color threshold algorithm, only interrupts with the slower neural net inference rarely enough that it does not impact the operation, and increases the robustness of the color threshold algorithm in changing environments.

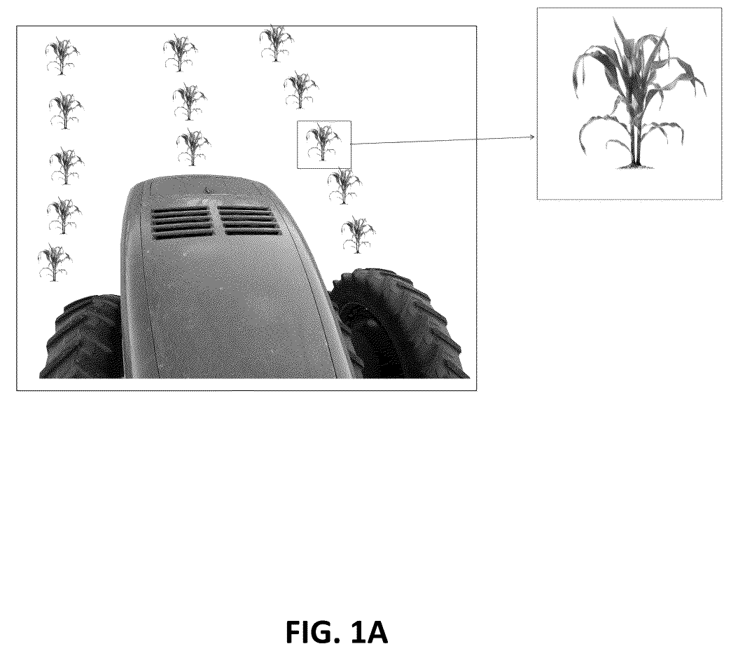

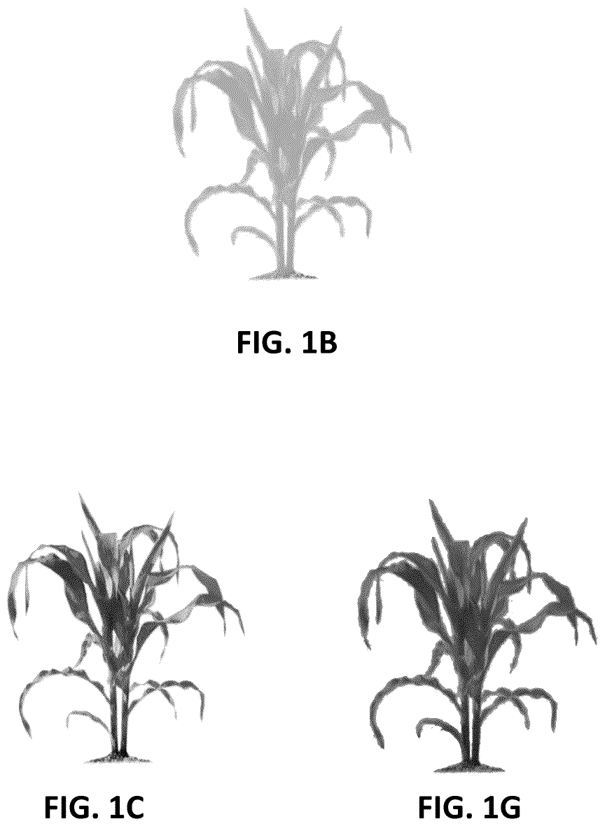

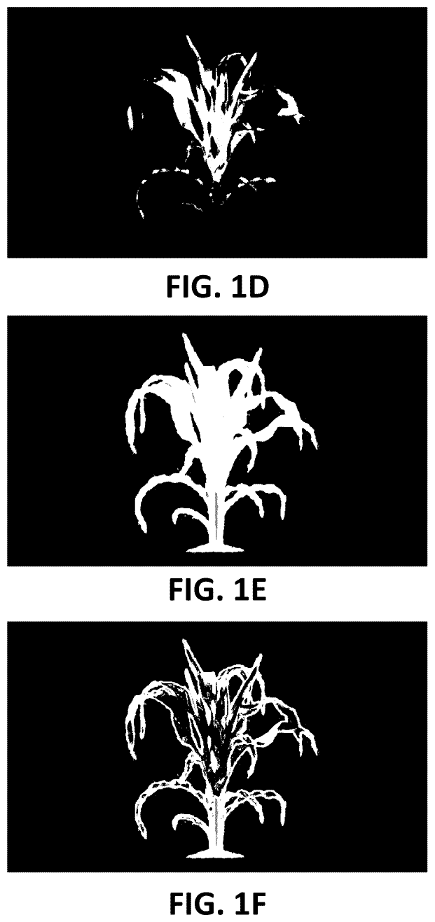

FIGS. 1A, 1B, 1C, 1D, 1E, 1F, and 1G illustrate using a neural net correcting color threshold. FIG. 1A illustrates a plant identified by a neural net. FIG. 1B illustrates a neural net semantic separated plant. FIG. 1C illustrates a color threshold plant selection. FIG. 1D illustrates a color threshold plant mask. FIG. 1E illustrates a neural net plant mask. FIG. 1F illustrates another neural net plant mask. FIG. 1G illustrates a color threshold algorithm post threshold update.

FIGS. 1A through 1G illustrate the process and results of using a neural network to dynamically correct and optimize color threshold parameters for plant identification in agricultural applications.

FIG. 1A is a pictorial representation of an original image captured by a camera mounted on an agricultural vehicle, showing a young crop plant against a soil background under natural field lighting conditions. This represents the raw input that both the neural network and color threshold algorithms process. The image demonstrates the typical variability in lighting, soil conditions, and plant appearance that agricultural vision systems must accommodate.

FIG. 1B illustrates the output of a neural network that has been trained to identify plants through semantic segmentation. In this image, the neural network has precisely separated the plant from the surrounding soil and debris, providing a high-confidence identification of the plant structure. Different colors may be used to represent different plant parts (such as leaves, stems, or emerging structures), demonstrating the neural network's ability to distinguish fine details within the plant itself. This semantic separation serves as the reference standard against which the color threshold algorithm's performance will be measured.

FIG. 1C shows the result of applying the current color threshold algorithm to the original image from FIG. 1A. In this visualization, pixels falling within the preset color threshold ranges are highlighted or enhanced, illustrating which portions of the image the algorithm currently identifies as potentially belonging to a plant. This representation demonstrates the algorithm's current parameter settings before any optimization occurs, and may reveal areas where the color threshold algorithm is either missing plant material or incorrectly identifying non-plant elements.

FIG. 1D depicts the binary mask generated by the color threshold algorithm based on the processing shown in FIG. 1C. In this binary representation, white pixels indicate areas the color threshold algorithm has classified as plant material, while black pixels represent areas classified as non-plant (soil, debris, etc.). This mask provides a clear visualization of the algorithm's current performance and will be directly compared with the neural network's mask to calculate error scores.

FIG. 1E shows the binary mask generated from the neural network's semantic segmentation shown in FIG. 1B. Similar to FIG. 1D, white pixels represent areas the neural network has identified as plant material, and black pixels represent non-plant areas. This mask serves as the reference against which the color threshold algorithm's performance will be evaluated. The precision of the neural network's plant detection capabilities is evident in the clear delineation of the plant's structure.

FIG. 1F illustrates a second neural network plant mask from a different image or time period, demonstrating how the neural network consistently identifies plants under varying conditions. This figure may show a different plant growth stage, lighting condition, or field environment, highlighting the neural network's robust detection capabilities across diverse situations. The consistent performance of the neural network across varying conditions underscores its value as a reference standard for calibrating the color threshold algorithm.

FIG. 1G demonstrates the improved result from the color threshold algorithm after its parameters have been updated based on comparison with the neural network masks. This image shows the binary mask generated by the color threshold algorithm using the optimized threshold values derived through the error minimization process. The enhanced accuracy of plant detection is evident when compared to the original color threshold mask in FIG. 1D, with better alignment to the neural network results shown in FIG. 1E. This figure illustrates the successful adaptation of the color threshold algorithm to more closely match the neural network's superior detection capabilities while still maintaining computational efficiency.

Together, these figures visually represent the complete process of neural network-guided optimization of color threshold parameters, from initial image capture through neural network processing, error calculation, threshold adjustment, and final improved performance.

### Adjust Values Based on Growth Stage

Plant identification and row-detection algorithms, including those based on color thresholding, neural networks, and other analytical methodologies, rely on specifically tuned parameters for accurate performance. Such parameters may include, but are not limited to, color intensity thresholds, confidence intervals, expected plant dimensions (such as widths or heights), inter-row spacing, plant density, or other relevant metrics. However, as plants develop from germination through maturity, their visual and structural characteristics change significantly. These developmental variations frequently result in periods during which conventional plant identification or row detection algorithms may underperform or fail unless their parameters are dynamically or periodically recalibrated.

The present disclosure addresses this challenge by utilizing an image classifier neural network or other suitable image recognition system to automatically detect the growth stage of the target plants and accordingly adjust or select optimal algorithm parameters. In practical operation, either before initiating plant detection or continuously throughout the detection process, at least one camera captures real-time images of the agricultural field. These images are input into a trained image classifier configured specifically to recognize and categorize distinct growth stages of the plant species of interest.

For example, corn plants progress through well-defined stages such as VE (emergence), V1 (first leaf collar visible), V2, and subsequent developmental stages up to maturity. The classifier identifies the particular growth stage present in the captured image. Based on this identified growth stage, the system retrieves and loads an appropriate, preconfigured set of parameters specifically optimized for accurate detection of plants or rows at that identified stage. This parameter set adaptation allows the follow-on plant or row detection algorithms to operate with heightened reliability and precision across all relevant stages of the plant life cycle.

This dynamic adaptation can occur as a single initialization step before field operations commence, or as an iterative, continuous calibration throughout field operations to accommodate rapid plant growth or varying conditions across different field segments. Consequently, the disclosed approach significantly enhances algorithm performance and detection accuracy, minimizing operational downtime and reducing manual intervention typically associated with algorithm retuning.

### Example Plant in Known Location

Color threshold algorithms may be dynamically adjusted if there is a known good sample with a known position and shape being exposed to the same lighting conditions. Neural net algorithms may be dynamically adjusted by passing known good bounding boxes or semantic separation masks from an image exposed to the same lighting conditions as the field. This technique involves placing a sample target plant onto a known stark background, such as white or magenta background, and in a known location relative to the camera. For example, a small magenta plastic square may be installed on the hood of the tractor and facing flush with the camera along with clips to hold the sample plant in place. A mask may be generated which preferably perfectly cuts out the sample space from the wider image. This mask when applied leaves the pixels of the sample space but blacks out all other pixels in the image.

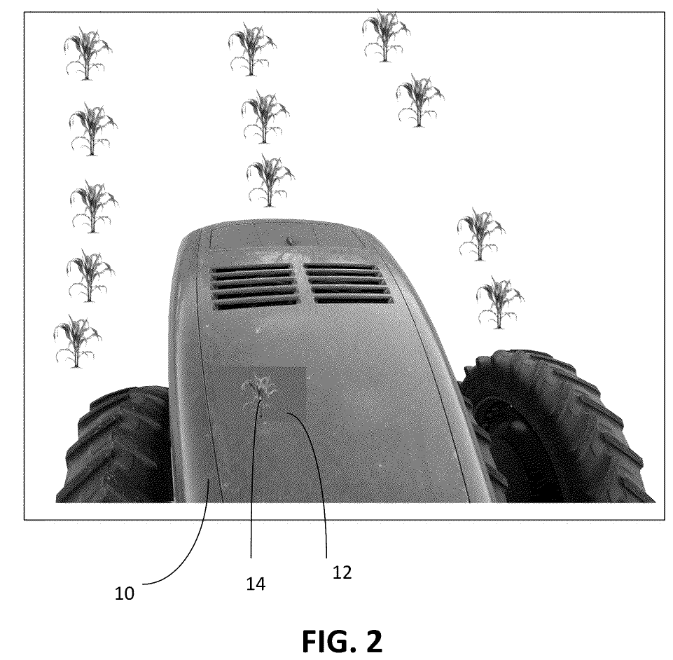

FIG. 2 illustrates the agricultural vehicle 10 such as a ground-based agricultural vehicle such as a tractor. A fixture 12 may have a stark or contrasting background. A sample plant 14 may be mounted at the fixture 12 such that the contrasting background facilitates automated isolation of the sample plant 14.

The sample plant 14 in the sample space may be easily and reliably cut out by removing all magenta colored, or whatever stark color is used, pixels from the image. This is different than the normal color threshold algorithm because it removes non-plant pixels that are colored an unnatural and easily identifiable color. In contrast, the plants in field conditions are surrounded by a wide variety of greens, browns and other harder to distinguish colors. The end result is ideally a perfect cutout of the plant in the sample space which does not include any pixels of the background.

In the example of a color threshold algorithm, the algorithm is run against just the portion of the image showing the sample space but including the background along with the sample plant. The color threshold algorithm outputs a mask which has white pixels for pixels whose color falls within threshold and black otherwise. The cut out sample image may be converted to a mask by setting any pixels not black to white. This cut out mask and the color threshold mask may be compared, the threshold adjusted, the error reduced and finally the threshold changed as described herein.

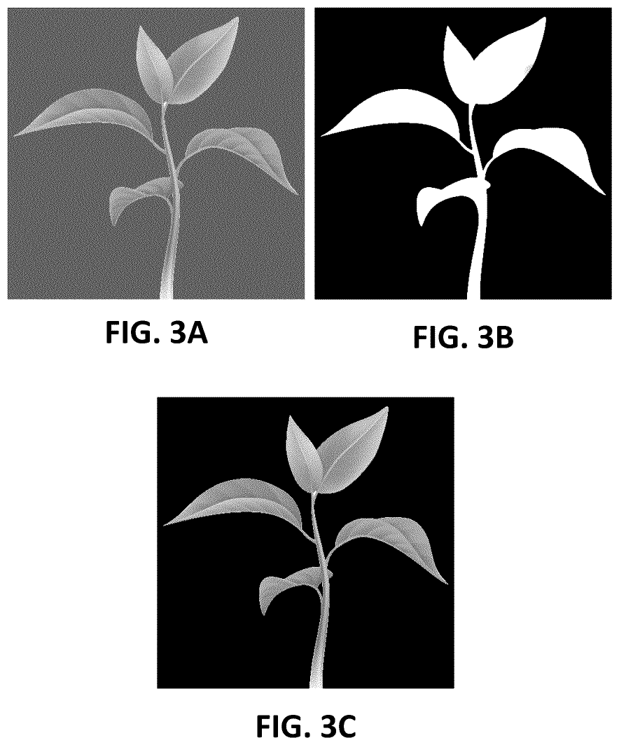

FIGS. 3A through 3C illustrate a method for creating a precise plant mask using a high-contrast background, which serves as a calibration element for dynamically adjusting plant detection algorithms.

FIG. 3A depicts a sample plant positioned against a starkly contrasting color such as a solid magenta background. The plant specimen is secured to a fixture with a uniform magenta surface that provides maximum color contrast with the green plant material. This arrangement creates a controlled environment for plant isolation within the camera's field of view. The magenta color may be selected because it rarely occurs in natural agricultural environments and has minimal overlap with the color spectra of plants or soil, making it ideal for automated separation. The sample plant shown represents a typical specimen of the crop being detected in the field, at a similar growth stage. This calibration setup may be mounted on the agricultural vehicle, positioned to experience the same lighting conditions as the field being processed.

FIG. 3B illustrates the process of removing all magenta-colored pixels from the image in FIG. 3A. In this step, the system applies a color filter that identifies pixels within a specific magenta color range and removes them from the image. The filtering operation creates a clear separation between the plant material and background by effectively making all background pixels transparent or null. This process is significantly more straightforward and reliable than attempting to directly identify plant material in complex field environments, as the magenta background (or other selected color) creates an unambiguous color distinction. The filtering parameters can be tightly defined around the specific magenta shade (or other selected color) used in the background fixture, ensuring consistent performance even under variable lighting conditions.

FIG. 3C shows the resulting binary plant mask after the background removal process is complete. This mask contains white pixels representing the plant material and black pixels where the background has been removed. The mask provides a highly accurate representation of the plant's exact shape, structure, and size without any background contamination. This clean isolation of plant material serves as a reference standard or ground truth against which the performance of field detection algorithms may be measured and calibrated. By comparing how the current color threshold or neural network algorithms detect this same plant against how it appears in this reference mask, the system can calculate precise adjustment values for algorithm parameters to optimize detection accuracy.

This series of figures demonstrates how a simple physical mechanism in the form of a distinctively colored background fixture with a representative plant sample may provide a reliable, automatically generated reference standard that enables continuous calibration of plant detection algorithms under changing field and lighting conditions. The high-contrast approach eliminates the ambiguity inherent in field imagery, creating a dependable calibration reference that experiences the same environmental conditions as the plants being detected in the field.

For neural nets, the training process involves generated annotated images to feed the neural net. The exact nature of the neural net changes the appropriate annotation but are all well known. Assuming semantic separation, knowing image classification and object detection annotations may always be generated from semantic separation annotations, the cut out of the plant from the sample space may be converted into a mask which has white pixels where the plant is and black where it isn't. This mask is exactly the form of annotation semantic separation neural nets require and may be used to dynamically re-train it.

In some embodiments, this technique may also use a separate camera placed to only see the sample space, but otherwise the technique remains the same.

### Color Reference Squares

The color reference square methodology provides a reliable, passive calibration mechanism that enables continuous adjustment of plant detection algorithms under varying field conditions. The system incorporates a series of precisely colored reference squares mounted at fixed positions relative to the camera on the agricultural vehicle. These squares are designed with colors specifically chosen to represent the key chromatic characteristics of target plants. The color squares are constructed from durable, weather-resistant materials that maintain color accuracy over time, sized appropriately to be clearly visible within the camera's field of view without occupying excessive image space, positioned where they experience the same lighting conditions as the field being observed, and arranged in a geometric pattern that facilitates automated identification based on their relative positions.

In some implementations, the color squares may contain actual plant material preserved through lamination or other stabilization techniques. This allows the reference colors to precisely match the target plant varieties' natural coloration. Alternatively, synthetic color patches may be calibrated to match specific plant characteristics such as healthy leaf coloration at various growth stages, stem coloration for different crop varieties, specific disease indicators or stress responses, or root or flower coloration where relevant.

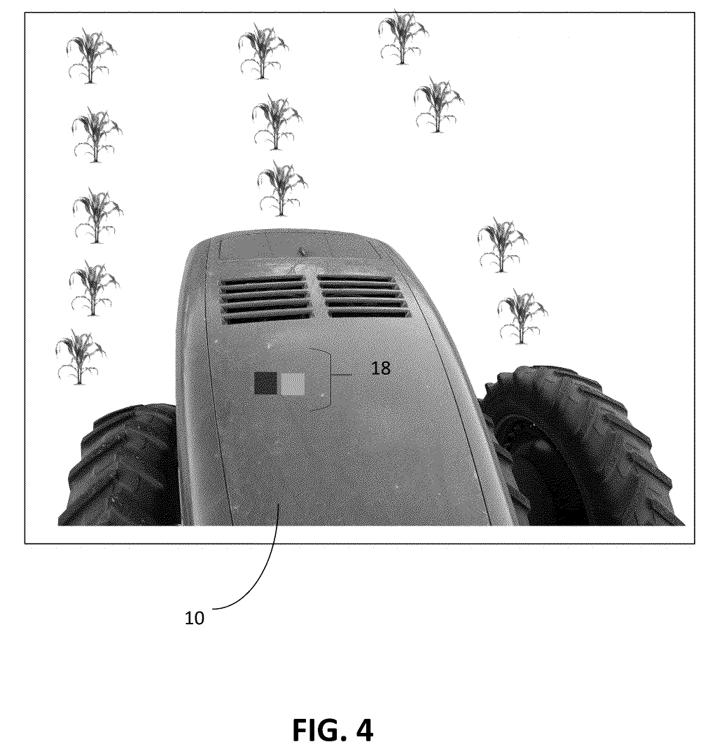

FIG. 4 illustrates using calibration elements in the form of calibration color squares 18 installed in a known location such as on a hood of an agricultural vehicle 10. As the vehicle traverses the field, each captured image frame includes both the agricultural field and the fixed reference squares. The system processes these images through a multi-step procedure. First, the reference squares are automatically identified within each frame using their known fixed position relative to the camera. The identified square regions are then extracted from the image, creating small sub-images containing only the calibration squares. These sub-images of the color squares are processed through the current color threshold algorithm using the same parameters applied to the field imagery. Since the expected classification of each color square is predetermined (plant or non-plant), the system can evaluate whether the current threshold settings correctly classify each square. Any discrepancies between expected and actual classification results indicate potential threshold calibration issues that require adjustment.

Based on the detection results from the color squares, the system calculates precise adjustments to the color threshold parameters. For each color square that should be identified as plant material but is not detected, the threshold ranges may need widening in specific color dimensions. For each reference square that should not be identified as plant material but is incorrectly detected, the threshold ranges may need narrowing. The system may quantify the exact difference between the current threshold boundaries and the color values of misclassified squares. These differences are used to calculate specific adjustment values for each threshold parameter, such as RGB ranges, HSV boundaries, or other color space values. The calculated adjustments are then applied to the color threshold algorithm, recalibrating it to current lighting conditions.

The color square evaluation can occur continuously with each frame or at specified intervals. Continuous evaluation allows immediate response to rapid lighting changes, periodic evaluation reduces computational overhead during stable conditions, and triggered evaluation can occur when significant lighting changes are detected through other sensors.

The color reference square approach offers several distinct advantages over alternative methods. It provides passive operation, unlike systems requiring active intervention, as the reference squares provide continuous calibration without operator involvement. It offers computational efficiency since the small, fixed regions of the squares require minimal processing resources compared to whole-frame analysis. The system creates direct color correlation, as the squares can be precisely calibrated to represent specific plant features of interest, creating direct color relationships. Environmental synchronization is achieved because, being mounted on the vehicle, the squares experience generally identical lighting conditions to the field, ensuring relevant calibration. The approach also supports multispectral compatibility and may be extended to include squares calibrated for near-infrared or other spectral ranges when using multispectral cameras.

Beyond basic detection, the color reference square methodology supports advanced detection capabilities. Calibration squares in multiple shades of green may help distinguish between crop varieties, while reference squares representing common disease indicators enable early stress detection. Squares matching soil color ranges under different moisture conditions improve ground/plant differentiation, and gradient squares showing transitions between healthy and stressed plant coloration enable precise health assessment. By maintaining accurate color calibration across changing environmental conditions, this technique assists plant analysis algorithms to maintain their reliability throughout daily and seasonal lighting variations.

### Incident Light Color Temperature and Intensity Sensor

Sensors exist that return the color spectrum of incident light falling upon it. One method of reporting a spectrum is color temperature, the temperature at which a black body would emit radiation of the same color as a given object. Such a sensor pointed at the sky may track changes in the color temperature of the incident light resulting from time of day and weather changes. The sensor may ideally be placed in a location where the light falling upon it is similar in color temperature and intensity to the light falling upon the plants being detected by the visual detection system. That same sensor may also report the color temperature of artificial lighting from a vehicle or static source. If multiple light sources provide illumination, each with its own unique color temperature, the sensor may report the cumulative effects on the overall color temperature falling on the sensor. That same sensor may simultaneously report the intensity of the incident light falling upon it. One example of such a sensor is the Sekonic C-800-U SPECTROMETER, although any number of other sensors may be used.

The color thresholds chosen for locating plants or other object classes are generated while this sensor is present and recording the incident light color temperature and light intensity. This ties a color temperature and intensity of incident light to the thresholds in the algorithm. Alternately, a predefined table of color temperatures, light intensities, and associated algorithm thresholds may be used.

As the incident light color temperature and intensity change, the reported temperature returned from the sensor will also change. The color temperature shift and light intensity may be described as a vector. For example, the sensor returns a color temperature of 5500 K and an intensity of 110,000 lux on a clear sunny day. As the day progresses, the sky may turn red and become darker. The sensor then returns a color temperature of 3200 K and an intensity of 300 lux. A vector may describe the shift in hue from blue to red and lightness from brighter to darker.

To adjust the thresholds in the color threshold algorithm, the vector describing the difference between the incident light color and intensity at the time the initial thresholds were generated may be compared to the incident light color and intensity at the current time. That vector is applied to each threshold in the algorithm to adjust for the new lighting conditions. Alternately, a predefined table of color temperatures and light intensities may be consulted to identify the closest match to the current incident lighting conditions, and then apply the algorithm thresholds associated with that lighting condition. Alternately, algebraic equations defining the algorithm thresholds based on incident light color temperature and intensity may be used.

Thus, various methods for dynamic light adjustment have been shown and described which may be used to visually detect agricultural plants in a field during varying weather and light conditions. The ability to visually detect plants in a field enables a number of different applications.

One such application is row following. Row following requires finding the plants or row of plants so that agricultural equipment may be guided therebetween. Existing algorithms find those plants or rows using some combination of color and depth. This technique allows those algorithms to be more robust to the significant color changes real field operations experience.

Other applications include those related to evaluating a plant or a plurality of plants for conditions relating to pests, disease, damage, or deficiencies. Detecting strains and stresses on plants requires an understanding of the normal color and shape of the plant. For example, nitrogen deficiency will cause corn to yellow from leaf tip and down to stem as the issue progresses. Cold weather snaps will brown and wrinkle the tips of leaves. Some fungal diseases will show as a browning near the center of leaves but not on the edges. This technique improves the robustness of algorithms requiring color to detect stresses on plants.

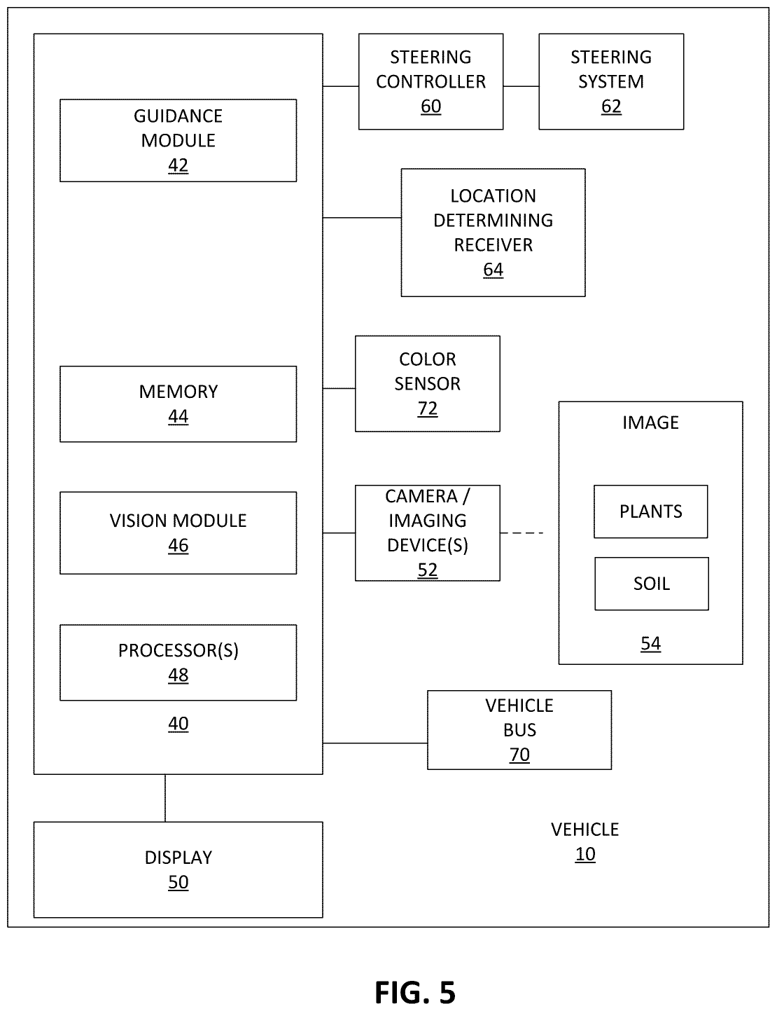

FIG. 5 illustrates a vehicle-mounted system suitable for dynamically adjusting machine vision algorithms to accurately identify plants and perform other agricultural operations under varying environmental lighting and plant growth conditions. As depicted, vehicle 10 includes a control system 40, which may integrate several modules for effective plant identification, guidance, and field management. The control system 40 may include a memory 44 and any number of different modules. In some embodiments the different modules may include software instructions which are stored in the memory 44 and executed on one or more processors 48. For example, a guidance module 42 may be configured to generate, access, and/or update guidance lines based on real-time visual data acquired from the field. The guidance module 42 may be operatively connected to a steering controller 60, which in turn directs a steering system 62, enabling precise vehicle positioning along crop rows or defined paths.

The guidance module 42 may interface with a location-determining receiver 64, such as a GPS receiver, to obtain accurate positional data. This positional information allows the guidance module 42 to correlate visual image data captured by the vehicle-mounted camera or other imaging device 52 with specific locations within the agricultural field. Utilizing image data captured sequentially, the control system 40 is capable of tracking line-based features, such as crop rows, across frames, facilitating accurate guidance line generation. Additionally, the control system 40 can perform other functions, such as detecting weed locations, differentiating between crop plants and weeds, identifying plant stress, and assessing plant health based on processed imagery.

Central to the control system 40 is a vision module 46, implemented through software instructions stored within a machine-readable memory 44 and executed by one or more processors 48. Alternatively, the vision module 46 may have dedicated processors and memory or share computing resources within the control system 40. The vision module 46 processes captured image data, performing plant and row detection and dynamically adapting algorithm parameters in response to real-time changes in environmental lighting conditions. To support this functionality, calibration elements may be placed within the camera's field of view provide baseline reference data, enabling the vision module 46 to detect lighting variations. When changes in environmental lighting conditions, such as shifting daylight, weather conditions, shadowing from passing objects, reflections, or even artificial illumination, are detected, the vision module 46 recalculates parameter adjustments and modifies settings within the machine vision algorithms. This dynamic adjustment ensures continuous reliability and precision in plant identification and row detection. The vision module 46 may also be used to identify growth stages of one or more plants and plant growth stage classifiers in performing calibrations.

The vision module 46 may be operatively connected to one or more cameras or imaging devices 52. Each of the one or more cameras or imaging devices may be operatively connected to an agricultural vehicle. As previously explained, in some embodiments a separate camera may be used to acquire imagery of plant samples. The one or more cameras or imaging devices 52 may capture imagery such as an image 54 which may include one or more plants or soil within an agricultural field and/or samples of one or more plants and/or soil.

A color sensor 72 is shown which may be a color temperature and/or intensity sensor. Where present, the color sensor 72 may be used as a calibration element to provide for data to be used for providing adjustment parameters to the algorithms used.

A display 50 is operatively connected to the control system 40, providing visual feedback and operational data to a vehicle operator. The display 50 presents real-time images 54 captured by the imaging device 52, displaying multiple crop rows, lanes between rows, and other relevant field features or any conventionally displayed information. The display 50 may also visually convey dynamically adjusted guidance lines, identified plants, detected weeds, plant growth stages, and indicators of current environmental lighting conditions. By presenting clear visual information, the display assists operators in monitoring system performance, confirming accuracy, and making manual interventions or corrections as needed.

The control system 40 may further interact with a vehicle bus 70, enabling data exchange and communication between the control system and various vehicle subsystems or attached agricultural implements. Via the vehicle bus 70, the control system may transmit and receive operational data, control implement settings, and manage agricultural equipment operations. Steering and other control commands may be sent directly through the vehicle bus 70 to the steering system 62 or to implement controllers. Consequently, the described system supports autonomous operation, semi-autonomous guidance, and operator-driven modes, maintaining accurate plant identification and guidance by continuously adapting to changing environmental lighting and plant growth conditions.

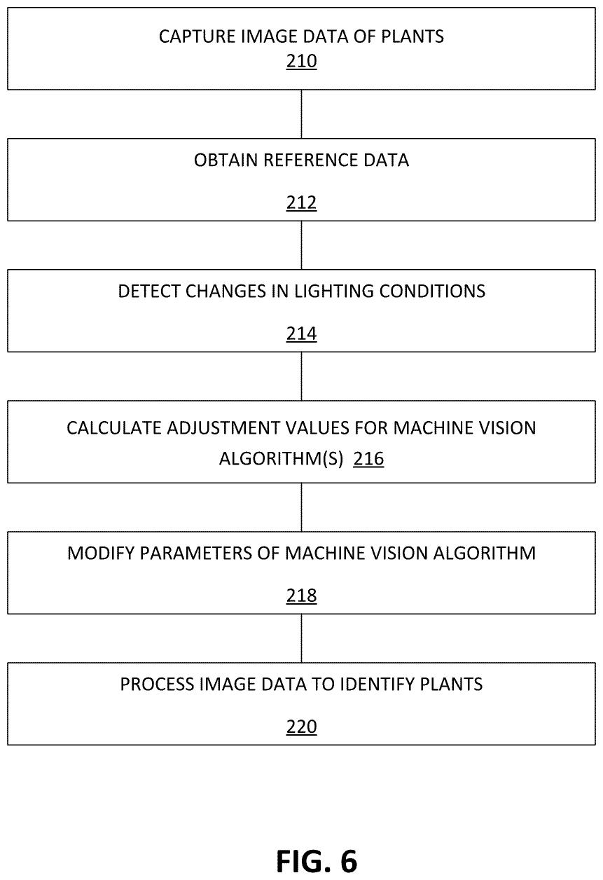

FIG. 6 illustrates a method for dynamically adjusting machine vision algorithms used in agricultural applications to reliably identify plants in a field under varying environmental lighting conditions. The illustrated method begins with step 210, in which at least one camera mounted on an agricultural vehicle or other image capture device captures image data of plants as the vehicle moves across an agricultural field. It is to be understood that the vehicle may be a ground-based vehicle, an aerial vehicle, or other type of vehicle.

At step 212, reference data is obtained such as from a calibration element positioned within the camera's field of view. The calibration element provides a consistent baseline for comparison to help account for any variations in lighting conditions that could affect the accuracy of the machine vision system. Examples of suitable calibration elements include a sample plant placed against a contrasting background, color calibration squares that exhibit predetermined color values, or a sensor that directly measures color temperature and intensity of ambient lighting. Of course, other types of reference data or calibration elements are contemplated. In some embodiments, the reference data may be obtained by classifying growth stage(s) of one or more plants within the field of view of the camera.

Next, at step 214, the method detects changes in environmental lighting conditions. One method of doing so is by comparing the current visual characteristics of the calibration element with previously recorded baseline visual characteristics. Environmental lighting conditions can change due to various factors, including the natural progression of daylight from morning through evening, changes due to weather conditions like cloud cover, fog, rain, shadows caused by passing equipment or field objects, reflections off wet surfaces, the presence of atmospheric particulates such as dust or haze, or even artificial illumination sources such as vehicle-mounted lights or nearby lighting fixtures.

Upon detecting changes in lighting conditions, step 216 involves calculating the necessary adjustment values for parameters used within the machine vision algorithm. For example, if the calibration element is a sample plant placed on a contrasting background, the system isolates the plant to create a reference mask and compares actual plant identification results from the machine vision algorithm against this mask. Alternatively, when color calibration squares are used, the system calculates adjustments by identifying differences between the expected and actual detected colors. If the calibration element is a sensor measuring color temperature and intensity, the system calculates adjustment values by computing a numerical difference between current sensor measurements and baseline measurements, using this difference to determine parameter adjustments for the algorithm.

At step 218, the calculated adjustment values are used to modify parameters within the machine vision algorithm. For instance, if the algorithm relies on color thresholding, the previously established threshold values are adjusted to maintain accuracy despite the detected lighting changes. Additionally, adjustments can be further refined by periodically running a neural network algorithm, comparing its high-accuracy plant identification outputs with those of the color threshold algorithm, calculating any differences in results, and then modifying threshold values accordingly to minimize these differences.

In some implementations, the method may also include classifying the growth stage of plants using an image classifier neural network. Upon identifying a particular growth stage, the system selects an appropriate set of baseline algorithm parameters optimized specifically for the detected stage. These growth-stage-specific parameters provide a starting point before adjustments for environmental lighting conditions are applied.

Finally, at step 220, the method processes the captured image data using the modified parameters of the machine vision algorithm. This processing step enables the system to accurately perform various functions critical to agricultural operations, including identifying plants, guiding equipment along rows, detecting plant stress indicators, and distinguishing between crop plants and weeds. By dynamically adapting algorithm parameters in response to real-time lighting conditions and plant growth stages, the method assists in providing consistent and reliable performance of the machine vision system throughout varying agricultural environments and conditions.

The foregoing disclosure provides illustration and description but is not intended to be exhaustive or to limit the implementations to the precise form disclosed. Modifications may be made in light of the above disclosure or may be acquired from practice of the implementations. As used herein, the term “component” or “module” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware may be used to implement the systems and/or methods based on the description herein. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more”. Further, as used herein, the article “the” is intended to include one or more items referenced in connection with the article “the” and may be used interchangeably with “the one or more”. Furthermore, as used herein, the term “set” is intended to include one or more items (e.g., related items, unrelated items, a combination of related and unrelated items, and/or the like), and may be used interchangeably with “one or more”. Where only one item is intended, the phrase “only one” or similar language is used. Also, as used herein, the terms “has”, “have”, “having”, or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or”, unless explicitly stated otherwise (e.g., if used in combination with “either” or “only one of”).

As used herein, “environmental lighting conditions” encompasses any changes in illumination or lighting conditions that may be associated with or influenced by the surrounding environment. This broadly includes variations resulting from natural sources, artificial sources, or interactions thereof. For example, environmental lighting changes may include, but are not limited to, differences in lighting caused by variations in time of day (such as sunrise, midday, sunset, or nighttime conditions), fluctuations due to weather patterns (including sunny, overcast, foggy, rainy, or stormy conditions), lighting changes caused by cloud cover, variations resulting from shadows cast by objects (such as trees, buildings, machinery, or passing equipment), atmospheric conditions like haze, dust, or particulate matter suspended in the air, reflections from surfaces including standing water, wet vegetation, or puddles, and artificial lighting alterations such as nearby vehicle headlights, equipment-mounted lights, streetlights, floodlights, or even indoor lighting conditions when operating within controlled environments or structures.

Where processes include a set of steps it is to be understood that the steps do not necessarily need to be performed in the order provided unless context expressly requires it in order for the process to be operational.

Where specific colors have been used within images to assist in visually understanding the imagery shown or for masking, it is to be understood that other colors may be used instead, or alternative methods may be used.

It is also to be understood that various features from different embodiments may be combined. For example, a system may include a processor configured to perform different methods of dynamically adjusting lighting and may select the best method for a particular situation or may provide for applying multiple methods and selecting the best result dependent upon the circumstances, or combine results from different methods to provide a better result. It is to be further understood that various features may be described within particular embodiments, but that certain features or methods may function independently with broader application than to the specific embodiments described.

It is to be understood that although the methodology has primarily been described using a land-based agricultural vehicle, the methodology may also be applied to aerial drones or other aerial vehicles as well as ground vehicles. Thus, an agricultural field may be traversed by a land-based vehicle traveling through a field or may be traversed by an aerial vehicle traveling over the field.

The disclosure is not to be limited to the particular aspects described herein. In particular, the disclosure contemplates numerous variations. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions may be made, which are within the intended spirit and scope of the disclosure.

What is claimed is:

1. A method for dynamically adjusting machine vision for agricultural applications, the method comprising:
capturing, via at least one camera mounted on an agricultural vehicle, image data of plants in an agricultural field;
obtaining reference data from a calibration element within the field of view of the at least one camera, wherein the calibration element provides a baseline for visual comparison under changing environmental lighting conditions;
detecting a change in environmental lighting conditions by comparing current visual characteristics of the calibration element to predetermined baseline visual characteristics;
calculating adjustment values for parameters of a machine vision algorithm based on the detected change in environmental lighting conditions;
modifying the parameters of the machine vision algorithm according to the calculated adjustment values; and
processing the image data with the modified machine vision algorithm to identify plants in the agricultural field.

2. The method of claim 1, wherein the calibration element comprises one selected from the group consisting of: a sample plant positioned on a contrasting background, color calibration squares with predetermined color values, and a color temperature and intensity sensor.

3. The method of claim 1, wherein: the machine vision algorithm comprises a color threshold algorithm with predetermined threshold values; and modifying the parameters comprises adjusting the predetermined threshold values to compensate for the detected change in environmental lighting conditions.

4. The method of claim 3, further comprising: executing a neural network algorithm at specified intervals to generate reference plant identification results from the image data; comparing output from the color threshold algorithm with output from the neural network algorithm to calculate an error score; and adjusting the predetermined threshold values of the color threshold algorithm to minimize the error score.

5. The method of claim 1, wherein detecting the change in environmental lighting conditions comprises: measuring at least one metric selected from the group consisting of: ambient light color temperature, light intensity, and color values of the calibration element; and calculating a numerical difference between current values and baseline values for each measured metric.

6. The method of claim 1, further comprising: classifying a growth stage of the plants in the agricultural field using an image classifier; and selecting a set of baseline algorithm parameters corresponding to the classified growth stage prior to modifying the parameters.

7. The method of claim 1, wherein: the calibration element comprises a sample plant positioned on a contrasting background; obtaining reference data comprises isolating the sample plant from the contrasting background to create a reference mask; and calculating adjustment values comprises comparing plant identification results from the machine vision algorithm with the reference mask.

8. The method of claim 1, wherein: the calibration element comprises color calibration squares with predetermined color values; obtaining reference data comprises capturing an image of the color calibration squares; and calculating adjustment values comprises determining differences between expected detection results and actual detection results for the color calibration squares.

9. The method of claim 1, wherein: the calibration element comprises a color temperature and intensity sensor; obtaining reference data comprises acquiring color temperature and intensity measurements from the sensor; detecting the change in environmental lighting conditions comprises calculating a numerical vector between current measurements and baseline measurements; and calculating adjustment values comprises applying the numerical vector to determine specific parameter modifications for the machine vision algorithm.

10. The method of claim 1, wherein processing the image data with the modified machine vision algorithm comprises performing at least one function selected from the group consisting of: plant identification, row guidance, plant stress detection, and weed discrimination.

11. A method for dynamically adjusting machine vision for agricultural applications, the method comprising:
capturing, via at least one camera mounted on an agricultural vehicle, image data of plants in an agricultural field;
obtaining reference data from at least a portion of a sample plant positioned within the field of view of the at least one camera, wherein the sample plant provides a baseline for visual comparison under changing environmental lighting conditions;
detecting a change in environmental lighting conditions by comparing current visual characteristics of the sample plant to predetermined baseline visual characteristics;
calculating adjustment values for parameters of a machine vision algorithm based on the detected change in environmental lighting conditions;
applying modified parameters to the machine vision algorithm according to the calculated adjustment values;
processing the image data with the machine vision algorithm with the modified parameters to identify plants in the agricultural field; and
wherein the machine vision algorithm applies color thresholding and a neural network to identify plants.

12. The method of claim 11, wherein the sample plant is mounted on a fixture having a contrasting background to facilitate automated isolation of the sample plant.

13. The method of claim 11, wherein processing the image data further comprises identifying crop rows and determining guidance lines for steering the agricultural vehicle between the identified crop rows.

14. A system for dynamically adjusting machine vision for agricultural applications, the system comprising:
at least one camera mounted on an agricultural vehicle configured to capture image data of plants in an agricultural field;
a calibration element positioned within a field of view of the at least one camera, wherein the calibration element provides a baseline for visual comparison under changing environmental lighting conditions;
a processor; and
a memory storing instructions that, when executed by the processor, cause the system to:
obtain reference data from the calibration element; detect a change in environmental lighting conditions by comparing current visual characteristics of the calibration element to predetermined baseline visual characteristics,
calculate adjustment values for parameters of a machine vision algorithm based on the detected change in environmental lighting conditions,
modify the parameters of the machine vision algorithm according to the calculated adjustment values, and
process the image data with the modified machine vision algorithm to identify plants in the agricultural field.

15. The system of claim 14, wherein the calibration element comprises one selected from the group consisting of: a sample plant positioned on a contrasting background, color calibration squares with predetermined color values, and a color temperature and intensity sensor.

16. The system of claim 14, wherein: the machine vision algorithm comprises a color threshold algorithm with predetermined threshold values; and modifying the parameters comprises adjusting the predetermined threshold values to compensate for the detected change in environmental lighting conditions.

17. The system of claim 16, wherein the instructions further cause the system to: execute a neural network algorithm at specified intervals to generate reference plant identification results from the image data; compare output from the color threshold algorithm with output from the neural network algorithm to calculate an error score; and adjust the predetermined threshold values of the color threshold algorithm to minimize the error score.

18. The system of claim 14, wherein the calibration element comprises a sample plant positioned on a contrasting background, and wherein obtaining reference data comprises isolating the sample plant from the contrasting background to create a reference mask.

19. The system of claim 14, further comprising a vehicle steering control system, wherein the instructions further cause the system to: identify crop rows in the agricultural field using the modified machine vision algorithm; determine guidance lines between the identified crop rows; and transmit control signals to the vehicle steering control system to guide the agricultural vehicle between the crop rows.

20. The system of claim 14, wherein the instructions further cause the system to: classify a growth stage of the plants in the agricultural field; and select a set of baseline algorithm parameters corresponding to the classified growth stage prior to modifying the parameters.
